(19) United States
(12) Patent Application Publication
(10) Pub. No.: US 2023/0006199 A1
(43) Pub. Date: Jan. 5, 2023

(54) COMPOSITE ELECTRODE COMPRISING A METAL AND A POLYMER MEMBRANE, MANUFACTURING METHOD AND BATTERY CONTAINING SAME

(71) Applicant: BLUE SOLUTIONS, Ergue-Gaberic (FR)

(72) Inventors: Margaud LECUYER, Combrit (FR); Sofia PERTICARARI, Quimper (FR); Marc DESCHAMPS, Quimper (FR)

(21) Appl. No.: 17/757,285

(22) PCT Filed: Dec. 22, 2020
(86) PCT No.: PCT/EP2020/087700

§ 371 Date: Jun. 13, 2022

(30) Foreign Application Priority Data
Dec. 27, 2019 (FR) 1915685

(51) Int. Cl. H01M 4/40; H01M 10/052; H01M 4/62

(52) U.S. Cl. CPC H01M 4/405; H01M 10/052; H01M 4/623; H01M 2004/027

(57) ABSTRACT

A composite negative electrode based on pure metallic lithium, pure metallic sodium or one of their alloys and a polymer membrane, a method for manufacturing such an electrode, as well as an electrical energy storage system, in particular an electrochemical accumulator such as a secondary (rechargeable) lithium or sodium battery comprising at least one such negative electrode. It is particularly applicable to Lithium-Metal-Polymer or LMP™ batteries.

The present invention relates to the general technical field of electrical energy storage systems.

More particularly, the present invention relates to a composite negative electrode based on pure metallic lithium, pure metallic sodium or an alloy thereof and a polymer membrane, a method of manufacturing such an electrode, as well as an electrical energy storage system, in particular an electrochemical accumulator such as a lithium-based or sodium-based secondary (rechargeable) battery comprising at least one such negative electrode. It applies quite particularly to Lithium-Metal-Polymer or LMP™ batteries.

LMP™ batteries are generally in the form of an assembly of superposed thin films (rolling or stacking with the following pattern (electrolyte/cathode/collector/cathode/electrolyte/anode) on n turns) or of n stacked thin films (cut and superposed, i.e. n stacks with the aforementioned pattern). This stacked/complexed unit pattern has a thickness of the order of about a hundred micrometres. It is made up of four functional layers: i) a negative electrode (anode) providing the supply of lithium ions during discharge of the battery, ii) a solid polymer electrolyte that conducts lithium ions, iii) a positive electrode (cathode) composed of an active electrode material acting as a receptacle where the lithium ions are inserted, and finally iv) a current collector in contact with the positive electrode and making it possible to provide the electrical connection.

The negative electrode of the LMP™ batteries is generally constituted by a sheet of pure metallic lithium or of a lithium alloy; the solid polymer electrolyte is generally composed of a polymer based on polyethylene oxide (PEO) and at least one lithium salt; the positive electrode is usually a material the working potential of which is below 4V vs Li+/Li (i.e. the insertion/deinsertion potential of lithium is below 4V) such as for example a metal oxide (for example such as V₂O₅, LiV₃O₈, LiCoO₂, LiNiO₂, LiMn₂O₄ and LiNi_{0.5}Mn_{0.5}O₂ etc.) or a phosphate of the type LiMPO₄, where M represents a metal cation selected from the group Fe, Mn, Co, Ni and Ti, or combinations of these cations, for example such as LiFePO₄, and also contains carbon and a polymer; and the current collector is generally constituted by a sheet of metal. Ion conductivity is provided by dissolution of the lithium salt in the polymer included in the composition of the solid electrolyte.

Sodium-ion (Na-ion) technology seems to be a promising alternative for a new generation of batteries, in particular in the field of stationary energy storage on account of the high natural abundance and low cost of sodium with respect to lithium.

Sodium batteries generally have a cathode in which the active material is a compound capable of inserting sodium ions reversibly, an electrolyte comprising a sodium salt that dissociates easily, and an anode whose active material may in particular be a sheet of pure metallic sodium or of a sodium-based alloy.

Thus, in both these types of batteries, the negative electrodes have in common that they are in the form of a very thin film, generally with a thickness less than approximately 100 μm. It is difficult to manufacture industrially and manipulate films of metallic lithium or of metallic sodium with a much smaller thickness, in particular on account of the very malleable and adherent character of these metals.

Various solutions for overcoming this technical problem have already been proposed in the prior art.

By way of example, international application WO 2013/121164 describes a negative electrode based on lithium or sodium in the form of a thin film, comprising (i) a reinforcement layer formed by a porous substrate, and (ii) a first and a second metal film based on lithium or sodium, the reinforcement layer being sandwiched between the two metal films based on lithium or sodium and bonded together by pressure to form a composite structure having a total thickness less than or equal to 100 μm in which the pores of the porous substrate are at least partly filled by the metal of the first and second metal films. According to this international application the porous substrate is a material that is not electrically conducting, and is in the form of a fibrous material, for example in the form of polymer fibres that are not electrically conducting. This negative electrode is therefore in the form of a composite structure with at least 3 layers, in which the two metal films constitute the upper and lower external faces of the electrode, with the porous substrate trapped between them. However, the technology proposed in this international application is not entirely satisfactory, as the cohesion between the metal films and the fibrous support is not always good. Moreover, the metal films present on each of the faces of the porous substrate may tear and/or become disconnected electrically from the rest of the electrode thus constituted, which has the effect of altering the performance of the electrode and battery comprising such an electrode.

There is therefore a need for a negative electrode that can be manipulated easily and comprises a thin film based on pure metallic lithium, pure metallic sodium or an alloy thereof, and does not have such drawbacks. There is also a need for a method for manufacturing such an electrode, the latter being thinner than the existing electrodes, and easily on an industrial scale.

These aims are achieved in particular with the negative electrode and the method of preparation thereof, which form the subject matter of the present invention and which will be described hereunder.

The present invention therefore relates firstly to a negative electrode that is in the form of a composite material comprising:

(i) at least one metallic layer based on pure lithium, pure sodium or an alloy of lithium or of sodium,
(ii) at least one polymer membrane comprising at least one polymer, said polymer membrane having two faces,
said electrode being characterized in that:
said polymer membrane is non-porous and is in direct physical contact, by at least one of its two faces, with said metallic layer,

said at least one polymer is selected from:

(a) electrically non-conducting polymers selected from the group comprising polyolefins; homopolymers and copolymers of ethylene oxide (e.g. PEO, PEO copolymer), of methylene oxide, of propylene oxide, of epichlorohydrin or of allylglycidyl ether, and mixtures thereof; halogenated polymers; homopolymers and copolymers of styrene and mixtures thereof; vinyl polymers; anionic polymers; polyacrylates; and one of the mixtures thereof; and
(b) electrically conducting polymers selected from the group comprising polyaniline, polypyrroles, polyfluorenes, polypyrenes, polyazulenes, polynaphthalenes, polycarbazoles, polyindoles, polyazepines, polythiophenes, poly(p-phenylene sulfides), polyacetylenes and poly(p-phenylene vinylenes).

Owing to the presence of this polymer membrane, very thin metal films (thickness generally less than or equal to approximately 45 μm) can be manipulated easily. This polymer membrane is chemically compatible with the metal of the metallic layer with which it is in contact by at least one of its faces. It is flexible and follows the shape of the grains of lithium or sodium. It is in particular capable of flowing between the grains of lithium or sodium to maintain the mechanical integrity of the metallic layer, even if there are tears in the latter. Finally, the polymer membrane of the negative electrode according to the invention has the particular feature of being able to stretch, at the same time as the metallic layer with which it is in contact during lamination of the electrode, each of the layers then becoming thinner in the same proportion.

Within the meaning of the present invention, when it is stated that the polymer membrane is non-porous, this means that it has a porosity less than or equal to 10% by volume, preferably less than or equal to 5% by volume with respect to the total volume of said membrane.

Also within the meaning of the present invention, when it is stated that the polymer membrane is in direct physical contact, by at least one of its faces, with said metallic layer, this means that no other layer will be interposed between said face of the polymer membrane and the metallic layer.

Still within the meaning of the present invention, when it is stated that the polymer membrane is chemically compatible with the metal of the metallic layer with which it is in contact, this means that the polymer is not altered on being brought into contact with the metal. In fact, although the polymer may be reduced at the surface of the membrane, the core of the membrane does not react chemically.

By way of polyolefins may be mentioned in particular the homopolymers or the copolymers of ethylene and of propylene, as well as mixtures of at least two of these polymers. By way of halogenated polymers may be mentioned in particular the homopolymers and the copolymers of vinyl chloride, of vinylidene fluoride (PVdF), of vinylidene chloride, of ethylene tetrafluoride, or of chlorotrifluoroethylene, the copolymers of vinylidene fluoride and of hexafluoropropylene (PVdF-co-HFP) and mixtures thereof. By way of anionic polymers may be mentioned in particular poly(styrene sulfonate), poly(acrylic acid), poly(glutamate), alginate, pectin, carrageenan and mixtures thereof.

According to the invention, the electrically non-conducting polymers are preferably selected from the homopolymers and the copolymers of ethylene oxide (e.g. PEO, PEO copolymer), the copolymers of vinylidene fluoride and hexafluoropropylene (PVdF-co-HFP) and mixtures thereof.

The polymer membrane of the negative electrode according to the invention may additionally contain at least one electron conduction additive. In this case, such an additive may in particular be selected from carbon-containing fillers such as carbon black, graphite, carbon fibres and nanofibres, carbon nanotubes and graphene; particles of at least one conductive metal such as aluminium, copper, gold, silver, platinum, iron, cobalt and nickel; and one of the mixtures thereof.

When it is present, the electron conduction additive preferably represents from approximately 5 to 80% by weight, and even more preferably from approximately 10 to 30% by weight, with respect to the total weight of the polymer membrane of the negative electrode.

According to the invention, the polymer membrane of the negative electrode is preferably an electrically conducting polymer membrane. In this case, the polymer membrane is electrically conducting, either because it comprises one or more electrically non-conducting polymers and at least one electron conduction additive, or because it comprises at least one electrically conducting polymer optionally in the presence of at least one electron conduction additive.

In fact, when the polymer membrane of the negative electrode according to the present invention is electrically conducting, grain-to-grain electrical conduction can be maintained even in the case of mechanical rupture or tearing of the metallic layer.

The polymer membrane of the negative electrode according to the invention may additionally contain at least one salt comprising at least one anion and at least one metal cation M.

The salts may in particular be selected from MBF₄, MPF₆, CF₃SO₃M (triflate), a bis(trifluoromethylsulfonyl)imide of a metal cation M (MTFSI), a bis(fluorosulfonyl)imide of a metal cation M (MFSI), a bis(pentafluoroethylsulfonyl)imide of a metal cation M (MBETI), MAsF₆, MCF₃SO₃, MSbF₆, MSbCl₆, M₂TiCl₆, M₂SeCl₆, M₂B₁₀Cl₁₀, M₂B₁₂Cl₁₂, MNO₃, MClO₄, a trifluoroimidazole of a metal cation M (MTDI), a tetrafluoroborate of a metal cation M (MFOB), a bis(oxalato)borate of a metal cation M (MBOB), M₃PO₄, M₂CO₃, and Na₂SO₄.

The metal cation M may be selected from lithium, beryllium, sodium, magnesium, aluminium, potassium, calcium, silver, rubidium, strontium, caesium, barium, radium and francium cations. Among such cations, lithium and sodium are preferred.

According to the present invention, lithium bis(trifluoromethylsulfonyl)imide (LiTFSI) is particularly preferred.

When the polymer membrane comprises a salt comprising at least one anion and at least one metal cation M, the amount of said salt then preferably represents from 5 to 30% by weight, and even more preferably from 10 to 25% by weight, with respect to the total weight of the polymer membrane.

The polymer membrane of the negative electrode according to the invention preferably has a thickness of approximately 2 to 50 μm, and even more preferably approximately 2 to 10 μm.

The metallic layer of the negative electrode generally has a thickness of approximately 1 to 50 μm, preferably approximately 5 to 30 μm.

According to a particular and preferred embodiment of the invention, the negative electrode further comprises at least one second metallic layer, said second metallic layer being in direct physical contact with the other face of said non-porous polymer membrane.

According to this particular embodiment of the invention, the negative electrode is therefore composed of at least three layers, namely, in this order, a first metallic layer, a layer of non-porous polymer membrane, and at least one second metallic layer.

In this case, the first and the second metallic layers are thus separated from one another by said non-porous polymer membrane.

According to this embodiment, the first metallic layer is preferably identical to the second metallic layer.

Within the meaning of the present invention, the term “identical” means that the first and the second metallic layers are constituted by the same metal or by the same alloy and that they have approximately the same thickness.

According to this particular embodiment, the total thickness of the electrode with at least three layers according to the present invention preferably varies from approximately 10 to 100 μm, and even more particularly from approximately 15 to 60 μm.

The negative electrode according to the invention may further comprise a current collector. In this case, said electrode comprises at least one electrically conducting non-porous polymer membrane and said current collector is in direct physical contact with said membrane. The current collector may for example be constituted by a sheet of copper or of a carbon-based porous material such as for example carbon fibres or a carbon grid.

According to a particular and preferred embodiment of the invention, the negative electrode comprises 5 layers and is constituted by, in this order, a first metallic layer, preferably of metallic lithium or lithium alloy, a first electrically conducting non-porous polymer membrane, a current collector, preferably made from copper, a second electrically conducting non-porous polymer membrane, preferably identical to the first electrically conducting non-porous polymer membrane, and a second metallic layer, preferably identical to the first metallic layer.

According to this embodiment, said negative electrode with 5 layers may have a thickness of approximately 10 to 100 μm, and preferably approximately 15 to 60 μm.

The present invention relates secondly to a method for preparing a negative electrode as defined according to the first subject of the invention. This method is characterized in that it comprises at least one step of application of a non-porous polymer membrane based on at least one polymer on at least one metallic layer based on pure lithium, pure sodium or an alloy of lithium or of sodium, said polymer being selected from:

(a) electrically non-conducting polymers selected from the group comprising polyolefins; homopolymers and copolymers of ethylene oxide (e.g. PEO, PEO copolymer), of methylene oxide, of propylene oxide, of epichlorohydrin or of allylglycidyl ether, and mixtures thereof; halogenated polymers; homopolymers and copolymers of styrene and mixtures thereof; vinyl polymers; anionic polymers; polyacrylates; and one of the mixtures thereof; and
(b) electrically conducting polymers selected from the group comprising polyaniline, polypyrroles, polyfluorenes, polypyrenes, polyazulenes, polynaphthalenes, polycarbazoles, polyindoles, polyazepines, polythiophenes, poly(p-phenylene sulfides), polyacetylenes and poly(p-phenylene vinylenes).

According to a first embodiment, the polymer membrane is manufactured by extrusion and then deposited on said metallic layer, for example by lamination.

According to a first particular variant of this first embodiment, the negative electrode is composed of at least three layers, namely, in this order, a first metallic layer, a layer of non-porous polymer membrane comprising two faces, and at least one second metallic layer and it is obtained by the complexing of the first and second metallic layers respectively on each of the faces of said non-porous polymer membrane. According to this first variant, the method preferably further comprises a step of lamination of the resultant three-layer composite between two rollers, optionally comprising co-rolling films, in order to reduce the total thickness of the three-layer composite.

According to a second particular variant of this first embodiment, the negative electrode is composed of at least five layers, and is constituted by, in this order, a first metallic layer, a first electrically conducting non-porous polymer membrane, a current collector, a second electrically conducting non-porous polymer membrane identical to the first electrically conducting non-porous polymer membrane, and a second metallic layer identical to the first metallic layer, and it is obtained according to a method comprising the following steps:

i) the complexing of a metallic layer on an electrically conducting non-porous polymer membrane, to obtain a two-layer composite,
ii) the complexing of the two-layer composite obtained above in step i) on each of the faces of a current collector, to obtain said negative electrode with at least 5 layers.

According to this second variant, the method preferably further comprises, between step i) and step ii), a step of lamination of the two-layer composite obtained in step i) between two rollers, optionally comprising co-rolling films, in order to reduce the total thickness of the two-layer composite.

According to a second embodiment, a composition comprising at least the polymer or polymers constituting the membrane, in solution in a solvent, is applied, for example by coating, directly on said metallic layer or on a supporting film that is then complexed on said metallic layer. Drying steps may then be carried out so as to cause evaporation of the solvent and the formation of said membrane.

Additional lamination steps may then be applied to the negative electrode according to the invention to reduce its total thickness. In this case, the thickness of each of the layers constituting the negative electrode according to the invention is reduced proportionally.

According to the invention, the lamination steps are preferably carried out at a temperature from 0 to 160° C., preferably from 20 to 130° C. As stated above, lamination may be carried out in the presence of at least one co-rolling film of polymer, for example of polyethylene terephthalate (PET). The force applied during the lamination steps may be selected from a range from 2·10³ to 3·10⁴ Pa, and preferably from 3·10³ to 1·10⁴ Pa approximately.

Finally, the invention relates thirdly to an electrical energy storage system comprising at least one positive electrode, at least one electrolyte and at least one negative electrode, characterized in that said negative electrode is a composite negative electrode as defined according to the first object of the invention. Among such storage systems for electrical energy may be mentioned lithium batteries and sodium batteries.

According to the invention, the energy storage system is preferably a lithium battery, and even more preferably an all-solid lithium battery comprising a solid polymer electrolyte such as for example Lithium-Metal-Polymer (LMP™) batteries.

According to a first particular embodiment, said lithium battery comprises at least one negative electrode composed at least 3 layers, namely, in this order, a first metallic layer, a layer of non-porous polymer membrane, and at least one second metallic layer.

According to a second particular embodiment, said lithium battery comprises at least one negative electrode composed of at least 5 layers, constituted by, in this order, a first metallic layer, a first electrically conducting non-porous polymer membrane, a current collector, a second electrically conducting non-porous polymer membrane, and a second metallic layer.

Preferably, the first and second metallic layers are identical to each other and the first and second electrically conducting non-porous polymer membranes are identical to each other.

According to this second particular embodiment, said battery is formed by the superposition of the following elements, in this order:

a positive electrode film comprising a current collector,

at least one film of electrolyte or of separator impregnated with electrolyte,

a 5-layer negative electrode according to the present invention and as defined above.

The positive electrode of a lithium battery is generally constituted by a current collector supporting a composite positive electrode comprising a positive electrode active material, optionally an electron conduction agent, and optionally a binder. The active material of the positive electrode is usually a material the working potential of which is below 4V vs Li⁺/Li (i.e. the insertion/deinsertion potential of the lithium is below 4V) such as for example a metal oxide (for example such as V₂O₅, LiV₃O₈, LiCoO₂, LiNiO₂, LiMn₂O₄ and LiNi_{0.5}Mn_{0.5}O₂ etc.) or a phosphate of type LiMPO₄, where M represents a metal cation selected from the group Fe, Mn, Co, Ni and Ti, or combinations of these cations, for example such as LiFePO₄, and also contains carbon and a polymer. The current collector generally consists of a sheet of metal, for example a sheet of aluminium.

The electrolyte of a lithium battery is preferably a polymer electrolyte, which is generally composed of a polymer based on polyethylene oxide (PEO) and at least one lithium salt.

### BRIEF DESCRIPTION OF THE DRAWINGS

The attached drawings illustrate the invention:

FIG. 1 shows the change of the relative capacity and of the efficiency of the battery from Example 3 compared to a control battery, as a function of the number of cycles;

FIG. 2 shows the change of the internal resistance of the battery from Example 3, compared to a control battery, as a function of the number of cycles;

FIG. 3 shows the change of the relative capacity and of the efficiency of the battery from Example 4, compared to a control battery, as a function of the number of cycles;

FIG. 4 shows the change of the internal resistance of the battery from Example 4, compared to a control battery, as a function of the number of cycles;

FIG. 5 shows the change of the relative capacity and of the efficiency of the battery from Example 6, compared to a control battery, as a function of the number of cycles;

FIG. 6 shows the change of the internal resistance of the battery from Example 6, compared to a control battery, as a function of the number of cycles;

FIG. 7 is a diagrammatic view of a composite negative electrode according to the invention comprising 5 layers (five-layer composites): lithium/conductive polymer membrane/copper collector/conductive polymer membrane/lithium;

FIG. 8 shows the change of the relative capacity and of the efficiency of the battery from Example 8, compared to a control battery, as a function of the number of cycles;

FIG. 9 shows the change of the internal resistance of the battery from Example 8, compared to a control battery, as a function of the number of cycles.

### EXAMPLES

### Example 1: Preparation of a Lithium Composite Negative Electrode Comprising an Electrically Conducting Polymer Membrane

1st Step: Preparation of an Electrically Conducting Polymer Membrane

A polymer composition was prepared by mixing 90% by weight of polyethylene oxide sold under reference PEO 1 L by the company Sumitomo Seika and 10% by weight of carbon black with the trade name Ketjenblack EC600JD from the company Akzo Nobel using a Plastograph® (Brabender), at a temperature of 100° C., at a speed of 80 revolutions per minute.

The mixture obtained was then laminated at 110° C. in the form of a membrane having a thickness of 10 μm.

2nd Step: Preparation of the Composite Negative Electrode

Two lithium strips with a thickness of 35 μm were laminated on either side of the polymer membrane obtained above in the preceding step to obtain a lithium/polymer membrane/lithium three-layer composite electrode (three-layer composite). Lamination was carried out under a pressure of 5·10⁵ Pa and at a temperature of 80° C.

The three-layer composite thus obtained was then laminated between two rollers, using two co-rolling films of polyethylene terephthalate (PET), at ambient temperature and under a pressure of 5·10³ Pa to obtain three-layer negative electrode films having a total thickness of 15-20 μm, which corresponds to approximately 7 μm of lithium on each face of the polymer membrane, the latter having a thickness of approximately 5 μm.

### Example 2: Preparation of a Lithium Composite Negative Electrode Comprising an Electrically Conducting Polymer Membrane

In this example, a composite negative electrode was prepared according to the method described above in Example 1, in all points identical to that of Example 1 above, except that in this example the thickness of the polymer membrane was fixed at 30 μm. A negative electrode was thus obtained, composed of two sheets of lithium with a thickness of approximately 11 μm arranged on either side of the polymer membrane (about 30 μm), which corresponds to a total thickness of the electrode of approximately 52 μm.

### Example 3: Manufacture of a Lithium Battery According to the Invention

The composite negative electrode obtained above in Example 1 was used to manufacture a lithium-metal-polymer (LMP™) battery.

A polymer electrolyte comprising 40% by weight of a copolymer of poly(vinylidene fluoride) and hexafluoropropylene sold under reference PVDF-HFP 21512 by the company Solvay, 48% by weight of polyethylene oxide (PEO 1 L) sold by the company Sumitomo Seika and 12% by weight of LiTFSI (Solvay) was prepared in a Plastograph® Brabender mixer at 130° C., at a speed of 80 revolutions per minute. The resultant mixture was then laminated at 130° C. between two films of siliconized PET. A polymer electrolyte film having a thickness of approximately 20 μm was obtained at the end of lamination.

A positive electrode comprising 74% by weight of LiFePO₄ (LFP) sold by the company Sumitomo Osaka Cement, 2% by weight of carbon black sold under the trade name Ketjenblack EC600JD by the company Akzo Nobel, 4.8% by weight of LiTFSI (Solvay) and 19.2% by weight of PEO (reference: PEO 1 L Sumitomo Seika) was prepared in a Plastograph® Brabender mixer at 80° C., at a speed of 80 revolutions per minute. The resultant mixture was then laminated at 80° C. on a current collector of coated aluminium (Armor).

A battery according to the present invention was then assembled by successive laminations of the assembly formed by the composite negative electrode as obtained above in Example 1, the polymer electrolyte film and the positive electrode. Lamination was carried out at a pressure of 5·10³ Pa and a temperature of 80° C. under air (dew point −40° C.) in small cells of the “pouch cell” type having a volume of approximately 10 cm³.

For comparison, a control battery, not according to the invention, was assembled using the same positive electrode, the same polymer electrolyte but using, as negative electrode, a single sheet of lithium with a thickness of 10 μm, fused to a PET supporting film to allow handling thereof. Assembly of the control battery was carried out under the same conditions as for the battery according to the invention.

These two batteries were then cycled at 80° C. on a Bitrode™ cycling bench with a charge/discharge rate equal to C/10-D/10 for the first cycle and C/4-D/2 for the subsequent cycles in order to evaluate their electrochemical performance.

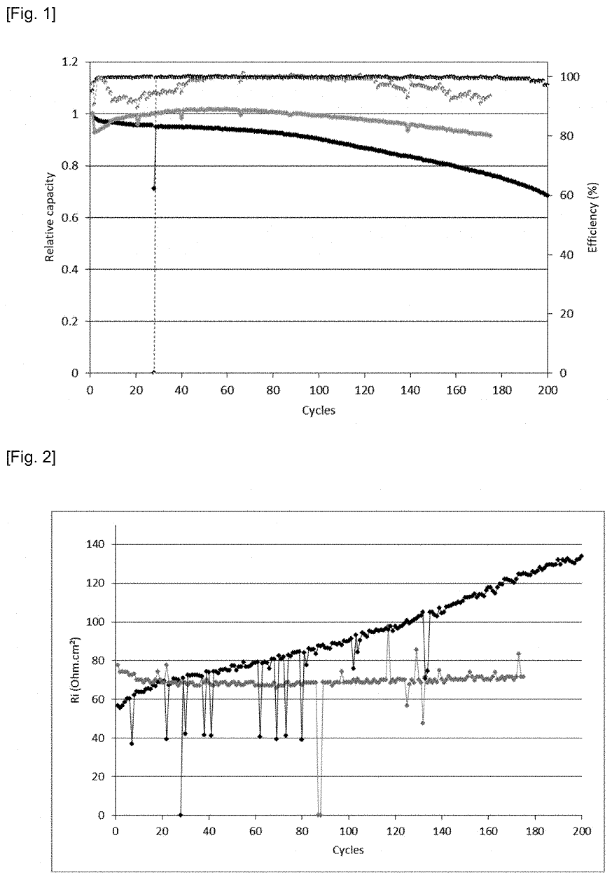

The results obtained are given in FIG. 1, where the relative capacity and the efficiency (%) are expressed as a function of the number of cycles for each of the two batteries. In this figure, the grey curves correspond to the change of the relative capacity and of the efficiency of the battery according to the present invention and the black curves correspond to the change of the relative capacity and of the efficiency of the control battery, not according to the present invention. The curves with filled diamonds correspond to the change of the capacity, whereas the curves with empty diamonds correspond to the change of the efficiency.

The results presented in FIG. 1 demonstrate that the efficiency and the relative capacity of the battery according to the present invention, i.e. comprising the composite negative electrode, are stable for about 120 cycles. The efficiency of the battery according to the invention begins to drop between the 120th cycle and the 150th cycle. In comparison, the control battery not according to the invention, i.e. in which the negative electrode is a single sheet of metallic lithium, has an efficiency and a relative capacity that are only stable for about twenty cycles.

Moreover, FIG. 2 shows the change of the internal resistance (Ri in ohm·cm²) as a function of the number of cycles, for the two batteries tested. In this figure, the grey curve corresponds to the change of the internal resistance of the battery according to the invention containing the composite negative electrode, whereas the black curve corresponds to the change of the internal resistance of the control battery, not according to the invention.

The results presented in FIG. 2 show that the internal resistances of these batteries have different changes. Whereas the battery according to the present invention shows stable internal resistance, the internal resistance of the control battery increases strongly in only 20 cycles. This demonstrates the better properties of the composite electrode according to the present invention with respect to a single sheet of lithium.

### Example 4: Manufacture of a Lithium Battery According to the Invention

The composite negative electrode obtained above in Example 2 was used to manufacture a lithium-metal-polymer (LMP™) battery according to the present invention according to exactly the same method as that described above in Example 3.

The polymer electrolyte film and the positive electrode were also the same as those prepared above in Example 3.

The performance of the LMP™ battery according to the present invention thus obtained was compared against that of a control battery not according to the invention, identical to the control battery prepared in Example 3 above.

The cycling conditions were also identical to those in Example 3.

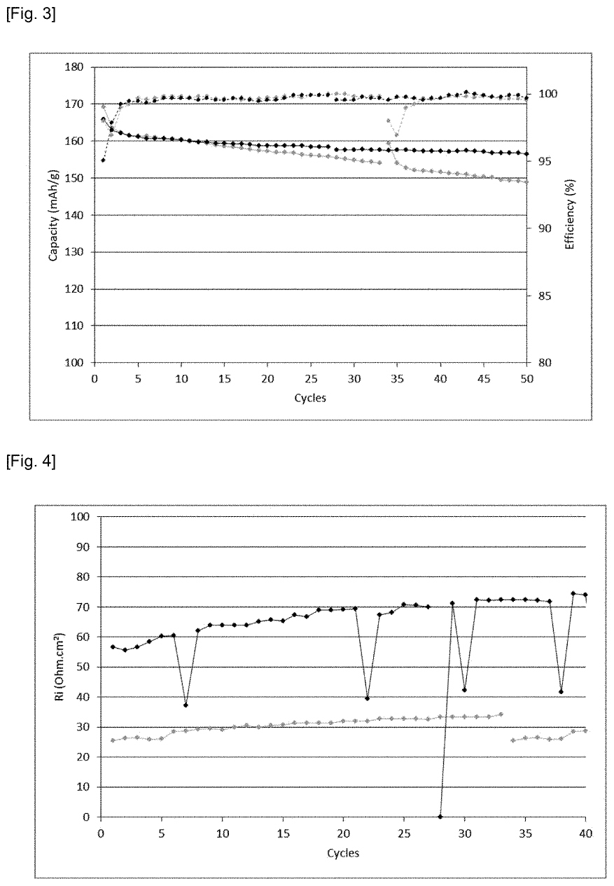

The results obtained are given in FIG. 3, where the relative capacity and the efficiency (%) are expressed as a function of the number of cycles for each of the two batteries. In this figure, the grey curves correspond to the change of the relative capacity and of the efficiency of the battery according to the present invention and the black curves correspond to the change of the relative capacity and of the efficiency of the control battery, not according to the present invention. The curves with filled diamonds correspond to the change of the capacity, whereas the curves with empty diamonds correspond to the change of the efficiency.

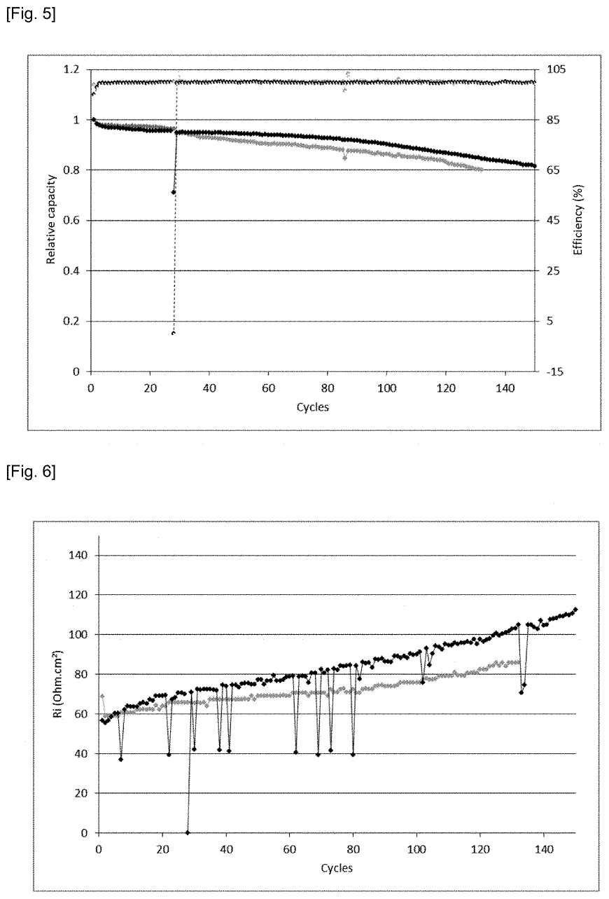

FIG. 4 shows the change of the internal resistance (Ri in ohm·cm²) as a function of the number of cycles, for the two batteries tested. In this figure, the grey curve corresponds to the change of the internal resistance of the battery according to the invention containing the composite negative electrode, whereas the black curve corresponds to the change of the internal resistance of the control battery, not according to the invention.

FIG. 3 shows that the change of the efficiency and of the capacity are comparable for the two batteries. However, the results presented in FIG. 4 show that the change of the internal resistances is somewhat different. In fact, the internal resistance of the control battery not according to the present invention increases more quickly than that of the battery according to the present invention, i.e. comprising the composite negative electrode. The operation of the battery according to the present invention is therefore better than that of the control battery.

### Example 5: Preparation of a Lithium Composite Negative Electrode Comprising an Electrically Non-Conducting Polymer Membrane

1st Step: Preparation of an Electrically Non-Conducting Polymer Membrane

A polymer composition was prepared by mixing 40% by weight of a copolymer of poly(vinylidene fluoride) and hexafluoropropylene sold under reference PVDF-HFP 21512 by the company Solvay, 48% by weight of polyethylene oxide (PEO 1 L) sold by the company Sumitomo Seika and 12% by weight of LiTFSI (Solvay) using a Plastograph® (Brabender), at a temperature of 130° C., at a speed of 80 revolutions per minute. The resultant mixture was then laminated at 130° C. until a membrane was obtained having a thickness of 14 μm.

2nd Step: Preparation of the Composite Negative Electrode

Two lithium strips with a thickness of 35 μm were laminated on either side of the polymer membrane obtained above in the preceding step to obtain a lithium/polymer membrane/lithium three-layer composite electrode (three-layer composite). Lamination was carried out under a pressure of 5·10⁵ Pa and at a temperature of 80° C.

The three-layer composite thus obtained was then laminated between two rollers, using two co-rolling films of polyethylene terephthalate (PET), at ambient temperature, at a pressure of 5·10³ Pa to obtain three-layer negative electrode films having a total thickness of 15-20 μm, which corresponds to approximately 7 μm of lithium on each face of the polymer membrane, the latter having a thickness of approximately 2 μm.

### Example 6: Manufacture of a Lithium Battery According to the Invention

The composite negative electrode obtained above in Example 5 was used to manufacture a lithium-metal-polymer (LMP™) battery.

A polymer electrolyte comprising 40% by weight of a copolymer of poly(vinylidene fluoride) and hexafluoropropylene sold under reference PVDF-HFP 21512 by the company Solvay, 48% by weight of polyethylene oxide (PEO 1 L) sold by the company Sumitomo Seika and 12% by weight of LiTFSI (Solvay) was prepared in a Plastograph® Brabender mixer at 130° C., at a speed of 80 revolutions per minute. The resultant mixture was then laminated at 130° C. between two films of siliconized PET. A polymer electrolyte film having a thickness of approximately 20 μm was obtained at the end of lamination.

A positive electrode comprising 74% by weight of LiFePO₄ (LFP) sold by the company Sumitomo Osaka Cement, 2% by weight of carbon black sold under the trade name Ketjenblack EC600JD by the company Akzo Nobel, 4.8% by weight of LiTFSI (Solvay) and 19.2% by weight of PEO (reference PEO 1 L; Sumitomo Seika) was prepared in a Plastograph® Brabender mixer at 80° C., at a speed of 80 revolutions per minute. The resultant mixture was then laminated at 80° C. on a current collector of coated aluminium (Armor).

A battery according to the present invention was then assembled by successive laminations of the assembly formed by the composite negative electrode as obtained above in Example 5, the polymer electrolyte film and the positive electrode. Lamination was carried out at a pressure of 5·10³ Pa and at a temperature of 80° C. under air (dew point −40° C.) in pouch cells.

By way of comparison, a control battery, not according to the invention, was assembled using the same positive electrode, the same polymer electrolyte but using, as negative electrode, a single sheet of lithium with a thickness of 10 μm, fused to a PET supporting film to allow handling thereof. Assembly of the control battery was carried out under the same conditions as for the battery according to the invention.

These two batteries were then cycled at 80° C. on a Bitrode™ cycling bench with a charge/discharge rate equal to C/10-D/10 for the first cycle and C/4-D/2 for the subsequent cycles in order to evaluate their electrochemical performance.

The results obtained are given in FIG. 5, where the relative capacity and the efficiency (%) are expressed as a function of the number of cycles for each of the two batteries. In this figure, the grey curves correspond to the change of the relative capacity and of the efficiency of the battery according to the present invention and the black curves correspond to the change of the relative capacity and of the efficiency of the control battery, not according to the present invention. The curves with filled diamonds correspond to the change of the capacity, whereas the curves with empty diamonds correspond to the change of the efficiency.

The results presented in FIG. 5 show that the efficiency and the capacity of the two batteries are stable and have comparable changes.

Moreover, FIG. 6 shows the change of the internal resistance (Ri in ohm·cm²) as a function of the number of cycles, for the two batteries tested. In this figure, the grey curve corresponds to the change of the internal resistance of the battery according to the invention containing the composite negative electrode, whereas the black curve corresponds to the change of the internal resistance of the control battery, not according to the invention.

The results presented in FIG. 6 show that the internal resistances of these batteries have different changes: the internal resistance of the battery not according to the invention shows a quicker increase than the battery according to the invention comprising the composite negative electrode. This demonstrates the better properties of the composite electrode according to the present invention with respect to a single sheet of lithium.

### Example 7: Manufacture of a Lithium Composite Negative Electrode Comprising a Current Collector

1st Step: Preparation of an Electrically Conducting Polymer Membrane

A polymer composition was prepared by mixing 90% by weight of polyethylene oxide sold under reference PEO 1 L by the company Sumitomo Seika and 10% by weight of carbon black with the trade name Ketjenblack EC600JD by the company Akzo Nobel using a Plastograph® (Brabender), at a temperature of 100° C., at a speed of 80 revolutions per minute.

The mixture obtained was then laminated at 110° C. in the form of a membrane having a thickness of 10 μm.

2nd Step: Preparation of the Composite Negative Electrode

A lithium strip with a thickness of 35 μm was laminated on one of the faces of the polymer membrane obtained above in the preceding step to obtain a two-layer lithium/polymer membrane composite electrode (two-layer composite). Lamination was carried out under a pressure of 5·10⁵ Pa and at a temperature of 80° C.

The two-layer composite thus obtained was then laminated between two rollers, using two co-rolling films of polyethylene terephthalate (PET), at ambient temperature and under a pressure of 5·10³ Pa to obtain a two-layer composite negative electrode film having a total thickness of 10 μm, which corresponds to approximately 7 μm of lithium on a membrane of 3 μm.

The two-layer composite thus obtained after this lamination was then applied on each of the two faces of a copper current collector having a thickness of 10 μm, by lamination at 80° C. under a pressure of 5·10³ Pa, so as to obtain a composite negative electrode with 5 layers (five-layer composites): lithium/conductive polymer membrane/copper collector/conductive polymer membrane/lithium having a total thickness of approximately 30 μm.

### Example 8: Manufacture of a Battery According to the Invention Comprising a Lithium Composite Negative Electrode Comprising a Current Collector

The composite negative electrode obtained above in Example 6 was used for making a lithium-metal-polymer (LMP™) battery.

A polymer electrolyte comprising 40% by weight of a copolymer of poly(vinylidene fluoride) and hexafluoropropylene sold under reference PVDF-HFP 21512 by the company Solvay, 48% by weight of polyethylene oxide (PEO 1 L) sold by the company Sumitomo Seika and 12% by weight of LiTFSI (Solvay) was prepared in a Plastograph® Brabender mixer at 130° C., at a speed of 80 revolutions per minute. The resultant mixture was then laminated at 130° C. between two films of siliconized PET. A polymer electrolyte film having a thickness of approximately 20 μm was obtained at the end of lamination.

A positive electrode comprising 74% by weight of LiFePO₄ (LFP) sold by the company Sumitomo Osaka Cement, 2% by weight of carbon black sold under the trade name Ketjenblack EC600JD by the company Akzo Nobel, 4.8% by weight of LiTFSI (Solvay) and 19.2% by weight of PEO (reference: PEO 1 L Sumitomo) was prepared in a Plastograph® Brabender mixer at 80° C., at a speed of 80 revolutions per minute. The resultant mixture was then laminated at 80° C. on a current collector of coated aluminium (Armor).

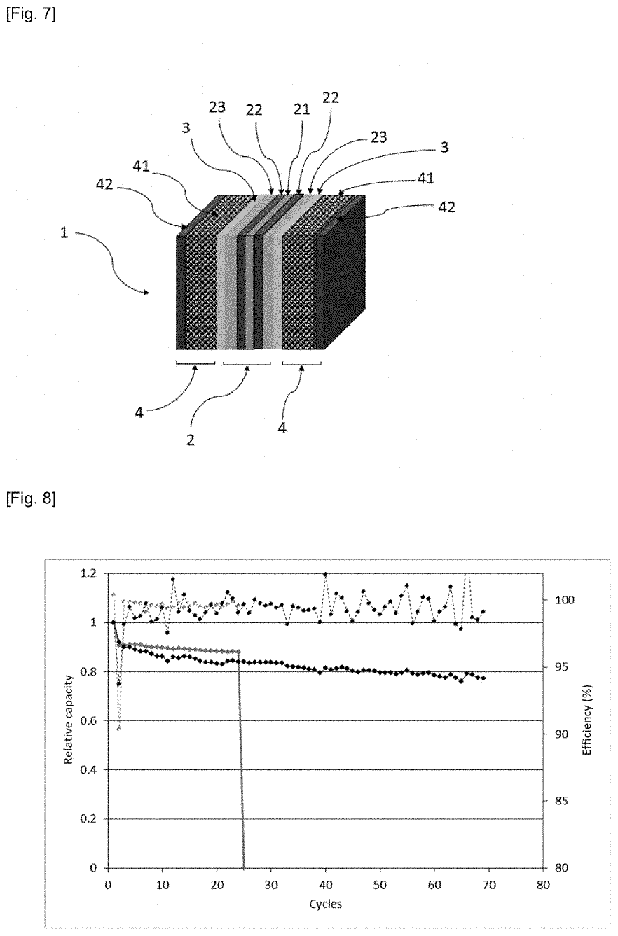

A battery according to the present invention was then assembled by successive lamination of an assembly comprising at the centre the negative electrode as prepared above in Example 6, surrounded on either side by two electrolytes and two positive electrodes as illustrated in the attached FIG. 7.

In this figure, the battery 1 comprises a composite negative electrode 2 comprising a copper current collector 21 comprising on each of its two faces a conductive polymer membrane 22, each of these two conductive polymer membranes 22 being in direct physical contact with a lithium sheet 23. Each lithium sheet 23 is in contact with a polymer electrolyte film 3 on the face opposite to the face that is in contact with the conductive polymer membrane 22, said polymer electrolyte films 3 themselves each being in contact with a positive electrode 4 comprising a layer of positive electrode material 41 in contact with a face of each polymer electrolyte 3, and an aluminium current collector 42.

Lamination was carried out at a pressure of 5·10³ Pa and a temperature of 80° C. under air (dew point −40° C.) in pouch cells.

For comparison, a control battery, not according to the invention, was assembled using a single sheet of lithium with a thickness of 30 μm in place of the composite negative electrode 2, the other constituent elements of the control battery (electrolytes and positive electrodes) being identical, moreover, to those of the battery according to the invention. Assembly of the control battery was carried out under the same conditions as for the battery according to the invention.

These two batteries were then cycled at 80° C. on a Bitrode™ cycling bench with a charge/discharge rate equal to C/10-D/10 for the first cycle and C/4-D/2 for the subsequent cycles in order to evaluate their electrochemical performance.

The results obtained are given in FIG. 8, where the relative capacity and the efficiency (%) are expressed as a function of the number of cycles for each of the two batteries. In this figure, the grey curves correspond to the change of the relative capacity and of the efficiency of the battery according to the present invention and the black curves correspond to the change of the relative capacity and of the efficiency of the control battery, not according to the present invention. The curves with filled diamonds correspond to the change of the capacity, whereas the curves with empty diamonds correspond to the change of the efficiency.

The results presented in FIG. 8 show that the change of the capacity and of the efficiency of the battery according to the present invention, i.e. comprising a 5-layer composite negative electrode 2, is more stable than that of the control battery not according to the invention comprising a single sheet of lithium by way of negative electrode.

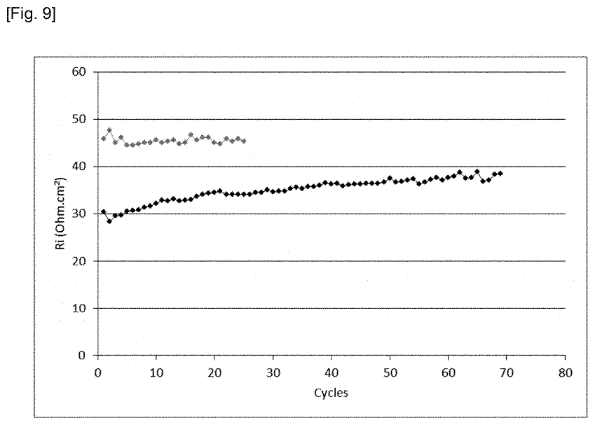

Moreover, FIG. 9 shows the change of the internal resistance (Ri in ohm·cm²) as a function of the number of cycles, for the two batteries tested. In this figure, the grey curve corresponds to the change of the internal resistance of the battery according to the invention containing the composite negative electrode, whereas the black curve corresponds to the change of the internal resistance of the control battery, not according to the invention.

The results presented in FIG. 9 show that even if the internal resistance of the battery according to the invention is higher initially than that of the control battery not according to the invention, the internal resistance of the battery according to the invention does not vary during the cycles of charging and discharging, whereas that of the control battery increases, thus reflecting degradation of the electrochemical performance of the battery. Thus, the use of a composite negative electrode according to the present invention leads to better cycling stability of the battery comprising same.

1. A negative electrode in the form of a composite material, comprising:
(i) at least one metallic layer based on pure lithium, pure sodium or an alloy of lithium or of sodium;
(ii) at least one polymer membrane comprising at least one polymer, said polymer membrane having two faces;
said polymer membrane is non-porous and is in direct physical contact, by at least one of its two faces, with said metallic layer;
said at least one polymer is selected from:
(a) electrically non-conducting polymers selected from the group comprising polyolefins; homopolymers and copolymers of ethylene oxide, of methylene oxide, of propylene oxide, of epichlorohydrin or of allylglycidyl ether, and mixtures thereof; halogenated polymers; homopolymers and copolymers of styrene and mixtures thereof; vinyl polymers; anionic polymers; polyacrylates; and one of the mixtures thereof; and
(b) electrically conducting polymers selected from the group comprising polyaniline, polypyrroles, polyfluorenes, polypyrenes, polyazulenes, polynaphthalenes, polycarbazoles, polyindoles, polyazepines, polythiophenes, poly(p-phenylene sulfides), polyacetylenes and poly(p-phenylene vinylenes).

2. The electrode according to claim 1, characterized in that the electrically non-conducting polymer or polymers are selected from homopolymers and copolymers of ethylene oxide, copolymers of vinylidene fluoride and hexafluoropropylene (PVdF-co-HFP) and mixtures thereof.

3. The electrode according to claim 1, characterized in that the polymer membrane is an electrically conducting membrane and in that it comprises:
either one or more electrically non-conducting polymers and at least one electron conduction additive;
or at least one electrically conducting polymer optionally in the presence of at least one electron conduction additive.

4. The electrode according to claim 1, characterized in that the polymer membrane additionally contains at least one salt comprising at least one anion and at least one metal cation M.

5. The electrode according to claim 4, characterized in that said salts are selected from MBF₄, MPF₆, CF₃SO₃M, a bis(trifluoromethylsulfonyl)imide of a metal cation M, a bis(fluorosulfonyl)imide of a metal cation M, a bis(pentafluoroethylsulfonyl)imide of a metal cation M, MAsF₆, MCF₃SO₃, MSbF₆, MSbCl₆, M₂TiCl₆, M₂SeCl₆, M₂B₁₀Cl₁₀, M₂B₁₂Cl₁₂, MNO₃, McIO₄, a trifluoroimidazole of a metal cation M, a tetrafluoroborate of a metal cation M, a bis(oxalato)borate of a metal cation M, M₃PO₄, M₂CO₃, and Na₂SO₄, M being selected from lithium, beryllium, sodium, magnesium, aluminium, potassium, calcium, silver, rubidium, strontium, caesium, barium, radium and francium cations.

6. The electrode according to claim 1, characterized in that the polymer membrane has a thickness from 2 to 50 μm, and in that the metallic layer has a thickness from 1 to 50 μm.

7. The electrode according to claim 1, characterized in that it further comprises at least one second metallic layer, said second metallic layer being in direct physical contact with the other face of said non-porous polymer membrane.

8. The electrode according to claim 7, characterized in that the first metallic layer is identical to the second metallic layer.

9. The electrode according to claim 1, characterized in that the non-porous polymer membrane is electrically conducting and in that said electrode further comprises a current collector, said current collector being in direct physical contact with said membrane.

10. A method for preparing a negative electrode as defined in claim 1, comprising at least one step of application of a non-porous polymer membrane based on at least one polymer on at least one metallic layer based on pure lithium, pure sodium or an alloy of lithium or of sodium, said polymer being selected from:
(a) the electrically non-conducting polymers selected from the group comprising polyolefins; homopolymers and copolymers of ethylene oxide, of methylene oxide, of propylene oxide, of epichlorohydrin or of allylglycidyl ether, and mixtures thereof; halogenated polymers; homopolymers and copolymers of styrene and mixtures thereof; vinyl polymers; anionic polymers; polyacrylates; and one of the mixtures thereof; and
(b) electrically conducting polymers selected from the group comprising polyaniline, polypyrroles, polyfluorenes, polypyrenes, polyazulenes, polynaphthalenes, polycarbazoles, polyindoles, polyazepines, polythiophenes, poly(p-phenylene sulfides), polyacetylenes and poly(p-phenylene vinylenes).

11. The method according to claim 10, for preparing a negative electrode composed of at least three layers, namely, in this order, a first metallic layer, a layer of non-porous polymer membrane comprising two faces, and at least one second metallic layer, said method being characterized in that said electrode is obtained by the complexing of first and second metallic layers respectively on each of the faces of said non-porous polymer membrane.
